(19) United States
(12) Patent Application Publication
(10) Pub. No.: US 2005/0071778 A1
(43) Pub. Date: Mar. 31, 2005

(54) Method for dynamic key size prediction with touch displays and an electronic device using the method

(75) Inventor: Timo Tokkonen, Oulu (FI)

Correspondence Address: HARRINGTON & SMITH, LLP, 4 RESEARCH DRIVE, SHELTON, CT, 06484-6212, US

(73) Assignee: Nokia Corporation, Espoo (FI)

(21) Appl. No.: 10/672,458

(22) Filed: Sep. 26, 2003

(51) Int. Cl. G06F 3/00

(52) U.S. Cl. 715/822; 715/812; 715/817; 715/819; 715/821

(57) ABSTRACT

The invention relates to a method for inputting user commands into an electronic device (1), which uses dynamic I/O input arrangement. After each input command the most potential next input command is emphasized by enlarging the size of a key of the command (23, 24, and 25). The invention also relates to a cellular terminal or PDA utilizing the method and software means to carry out the invention.

### FIELD OF THE INVENTION

The invention relates to a method for making easier to input user information into a small electronic device with a touch display or a so called projection display. The invention also relates to a cellular terminal utilizing the method and software means realizing the method.

### BACKGROUND OF THE INVENTION

Electronic devices become smaller and smaller all the time. Often these devices also have some kind of a display unit, which is usually also quite small. If the display of the electronic device is a so called touch display, it can be used in various ways. For example with the touch display a user can input information into the electronic device. In that case a normal keyboard with keys is not needed in the electronic device. Some examples of devices of this kind are cellular phones and personal digital assistants (PDA).

As mentioned above, the input of information into an electronic device can be carried out through a touch display. FIG. 1 illustrates an example of a user interface in a cellular phone 1 with a touch display of the prior art. The touch display 10 has several touch sensitive areas for number or character keys 11 and soft keys for menu selection. The selectable menus in the device are shown on a text or picture display area 12. In this prior art solution the touch sensitive keys 11 have about the same size and the display area 12 has a constant size. If the device itself is small, it brings about that also the keys 11 on the touch display 10 are quite small in size. That is why the keys are also hard to use.

Especially older people with an insufficient sight or movement control have serious problems in using this kind of small touch display of the prior art. Also for a novice user it can be difficult to know which key to press next when he or she is learning to use a new device or service. For all users it is a bit tedious to try to hit the correct key with a finger or a stylus, especially when all keys are “equal”, i.e. of same size.

To overcome the above-mentioned problems, for example following solutions are commonly used. In some cellular phones the most used keys are made bigger than other keys. So the user finds these keys very easily. However, this solution is static and there is no way to easily change the key configuration.

In some other known solution some of the keys, which are most probably used, are illuminated by light. Small LEDs can be used to indicate the most probable key to be pressed next. Also in this solution the key configuration must be designed beforehand and that is why it cannot be changed.

It is also known to utilize so called projection displays with electronic devices. Projection displays can be used to build up both (either) a display of the device and (or) its virtual user interface. In such systems the display or a keyboard of the electronic device is illuminated on a flat surface by some optical system. The illuminated display or keyboard can be zoomed smaller or bigger by the used optical system. However these systems are quite complicated and hence also expensive.

In the PC world it is known to use a high lighted dialog box to guide a user to proceed. This solution is basically possible also in small devices but it does not help in a situation where the user has a limited movement control.

### SUMMARY OF THE INVENTION

An object of the invention is to provide a new kind of user interface. The user interface according to the invention comprises a dynamic I/O arrangement, advantageously a touch display, in a mobile electronic device. The user interface according to the invention guides a user of the electronic device to select/press next the most apparent key, which can be deduced from the preceding key press.

The objects of the invention are achieved by a user interface with dynamically changing touch sensitive areas for keys and associated menus on the touch display. When the user of the electronic device presses or puts a stylus on a certain touch sensitive area, which is advantageously functioning as a number or character key on the touch display, in most cases one or some of the remaining keys are more probably to be pressed/selected next than the others. According to the invention, the most probable keys or selections are enlarged in size on the touch display to help the user to make his or her selection.

An advantage of the invention is that the user of the device can see the enlarged keys or selectable options better.

Another advantage of the invention is that the enlarged keys are also easier to use because the touch sensitive areas of these keys are bigger. A possibility to a selection error due to small key size is decreased.

Another advantage of the invention is that the enlarged keys or menus can guide the user of an electronic device to proceed in the process underway. So the first use of the electronic device can be made easier and quicker than with handbooks and such-like.

A further advantage of the invention is that the method according to the invention can be used as an unseen guiding agent.

Yet another advantage of the invention is that the user of the device can easily, if needed, by himself or herself enlarge or reduce the size of a certain touch sensitive areas on the touch display, which are advantageously used as keys of the device.

The idea of the invention is basically as follows: An electronic device, which is advantageously a cellular terminal or PDA utilizes a dynamic I/O method by which information units, such as numbers or characters, or commands selectable from a menu are input. Advantageously the mentioned I/O method utilizes a touch display or a projection display. The terminal advantageously also comprises a means according to the invention, which can control the size of an individual touch sensitive area advantageously used as a key for information input on the touch display. After a key press the means according to the invention decides which one of the keys on the user interface is the most probable or potential to be pressed next. If this decision or prediction is possible to make, the size of one key or some most probable keys, i.e. touch sensitive areas, are enlarged on the touch display according to the invention. If the next key pressing is directed to some other key than predicted, the size of the keys on the touch display are either restored to a size of the initial state or some other touch sensitive keys are enlarged, which enlargement depends on the selected/pressed preceding key.

The electronic device utilizes a method in which the user controls the electronic device by inputting a separate information unit. The information unit is advantageously input by elements of a dynamic I/O arrangement belonging to a user interface of the electronic device. After each input the information unit is identified and it is verified whether it is possible to predict which will be a next information unit to be input. If the prediction of the information unit is successful, at least one of input elements in the user interface of the electronic device is emphasized. Phases of this method are advantageously carried out by an appropriate computer program saved in the memory of the electronic device.

### BRIEF DESCRIPTION OF THE DRAWINGS

The invention is described in detail below. Reference is made to the accompanying drawings in which

FIG. 1 shows an example of a state of art terminal's touch display,

FIG. 2 shows an example of a touch display of an electronic device which can utilize the method according to the invention,

FIG. 3a shows an example of the touch display of an electronic device according to the invention where the size of three keys is enlarged,

FIG. 3b shows an example of the touch display of an electronic device according to FIG. 3a after the key “0” is pressed,

FIG. 4 shows, as an example, a flow chart including main stages of the method according to the invention, and

FIG. 5 shows, as an example, the main components of a wireless terminal where a method according to the invention is used.

### DETAILED DESCRIPTION

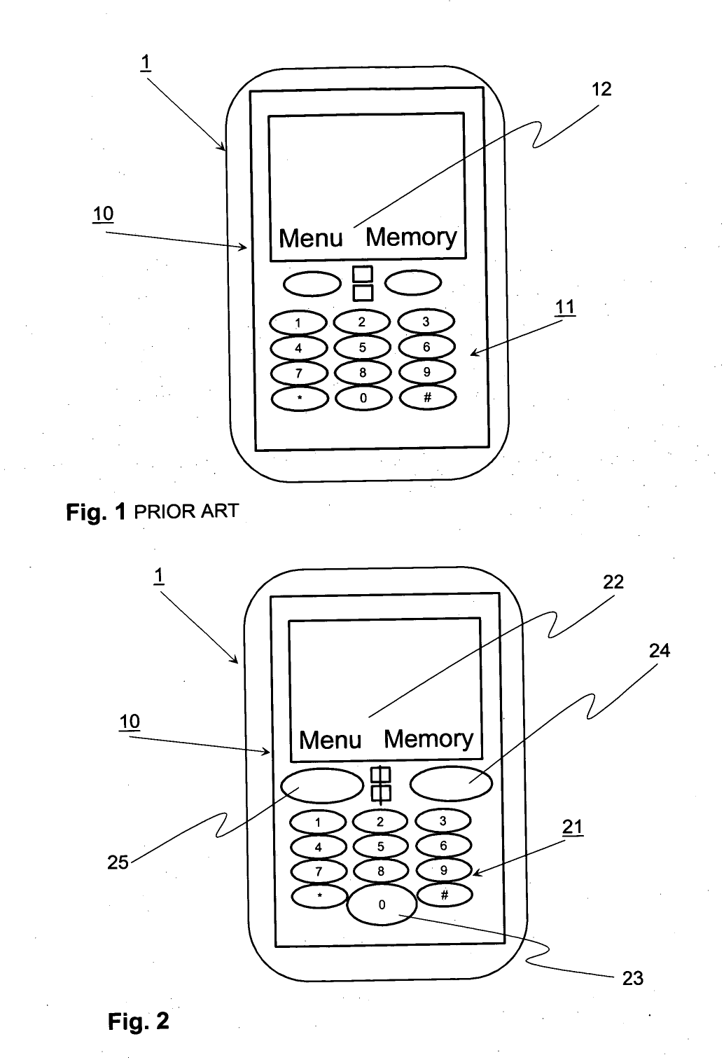

FIG. 1 was discussed in conjunction with the description of the prior art.

FIG. 2 illustrates an example of the display according to the invention used at a cellular terminal 1. The cellular terminal 1 contains advantageously a touch display 10. The touch display 10 in FIG. 2 comprises an area 22 where text or pictures can be shown and a second area 21 where input elements i.e. control keys and numbers/character keys of the cellular terminal are located. In the example of FIG. 2 three of the keys are enlarged. The keys for Menu, reference designator 25, for Memory, reference designator 24, and for number 0, reference designator 23, are enlarged. This can be the initial state of the touch display 10 when the terminal is in a standby mode or idle state. When a user makes the first key press, the most probable actions are: select menu soft key to choose some further action (press Menu), select memory soft key to find something in the memory of the device (press Memory) or begin to dial a phone number (press number 0).

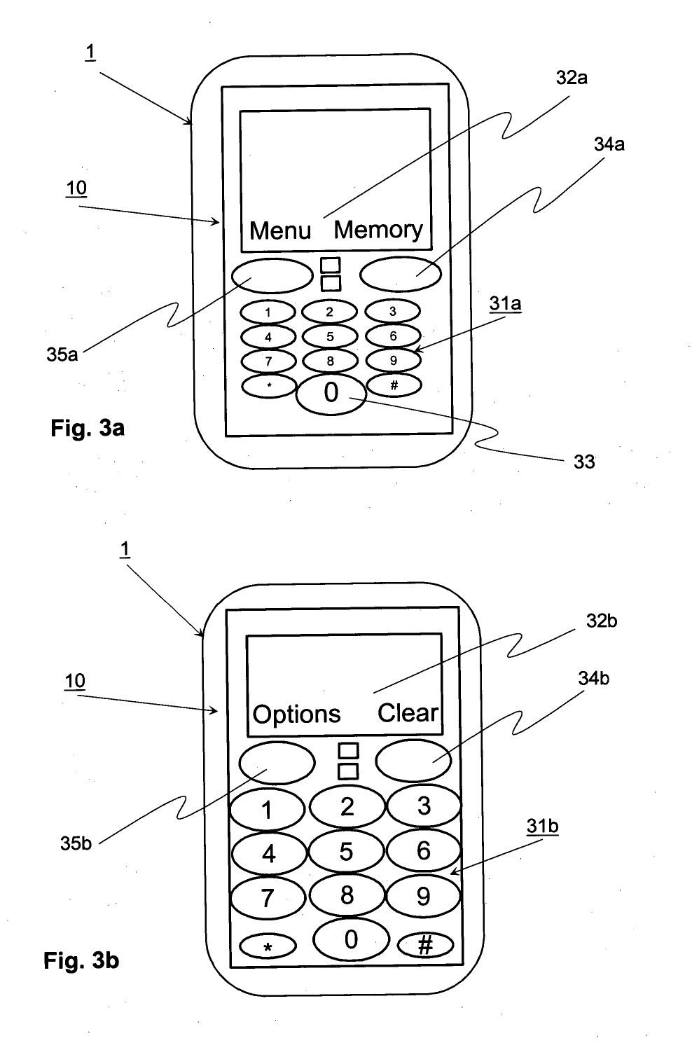

FIGS. 3a and 3b show an example how a touch display 10 according to the invention works. FIG. 3a shows a touch display according to the invention in the standby mode or an idle state of a terminal 1. The terminal 1 comprises advantageously a touch display 10 which is divided in two distinct parts. First part, reference designator, 32a comprises an area for text and pictures. In the example of FIG. 3a on this area is shown descriptive text of two soft keys, i.e. Menu, reference designator 35a, and Memory, reference designator 34a. The second part of the touch display 10, reference designator 31a, comprises input elements, i.e. control keys and/or number or character keys of the cellular terminal 1. In this part 31a of the touch display 10 the number key 0, reference designator 33, and the above-mentioned soft keys 34a and 35a can advantageously be enlarged. The key for number 0 is enlarged, because it is assumed that the first number to be pressed is in this exemplary cellular network most probably number 0. It is known to the man skilled in the art that any other number or character key can be in this position instead of number 0 in another cellular system.

Let us assume that the user presses the key for number 0. The situation after that on the touch display 10 is shown in FIG. 3b. This key press means that most probably the user is beginning to dial a phone number. So all the numbers on the touch display 10 are equally probable, because it is not known beforehand what number the user is going to dial. That is why all the number keys 31b are advantageously enlarged as big as possible to facilitate the dialing operation. On the other hand the area for text and pictures 32b is advantageously reduced in size, because it is evident that during dialing it is only used for showing the dialed numbers. At the same time also the descriptive text of the soft keys 34b and 35b is advantageously changed to Options and Clear, reference designator 32b. These are the most probable functions of the cellular terminal during dialing operation.

In an alternative embodiment of the present invention the size of an input element is not actually enlarged on a touch display or a projection keyboard. Instead the control logic of the device makes the enlargement internally. That means that the changed size of a certain input element is only known to the control logic. The enlargement is realized in practice, i.e. a bigger touch sensitive area for a predicted input element or a key on the touch display is reserved although its visible size is not changed.

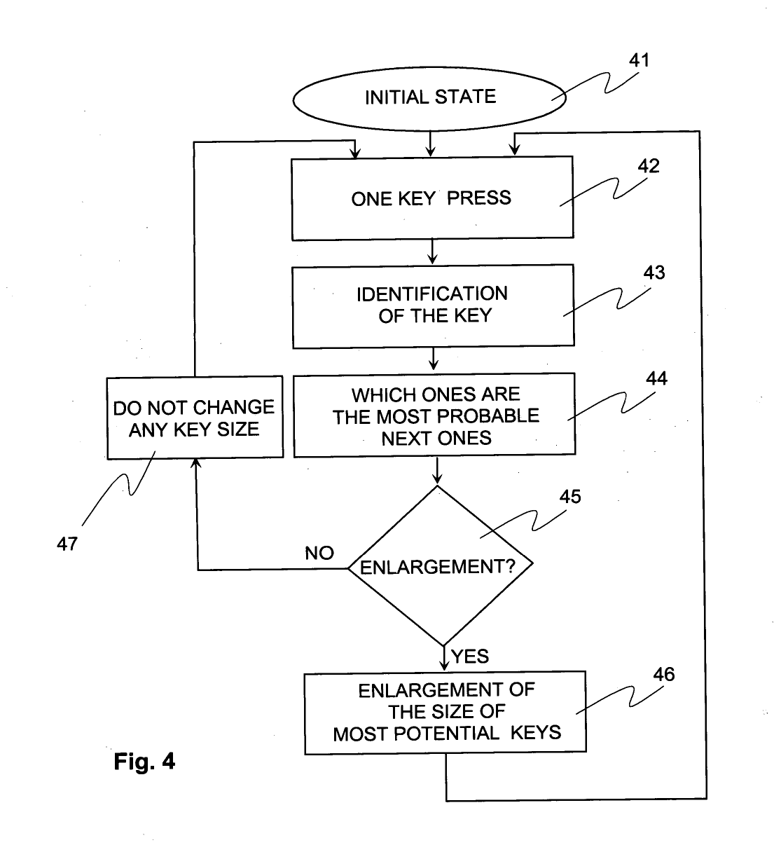

FIG. 4 illustrates in the form of an exemplary flow chart the main stages of the method according to the invention in an electronic device 1. The electronic device is advantageously a cellular terminal or PDA. FIGS. 3a and 3b are used for help in the following description.

In step 41 the electronic device 1 is in the standby mode or idle state. Therefore only three keys in FIG. 3a are advantageously enlarged. The enlarged keys can have advantageously different size. In the example of FIG. 3a the enlarged keys are Menu key 35a, Memory key 34a and key for number 0, reference designator 33.

In step 42 the user presses a key for inputting one information unit, i.e. a number or character, or a command selectable from a menu. The pressed key can be one of the enlarged keys or some other key. In step 43 the pressed key is identified.

In step 44 the most potential keys to be pressed next are evaluated. A decision about an enlargement is made in step 45 if there is a need to enlarge one or more keys on the display 10. If the decision in step 45 gives a negative answer, the process branches out to step 47. In step 47 it is decided that the key size remains unchanged compared to the situation before the key press. After that the process comes back to step 42 and a further key press is possible.

If in step 45 a positive decision is made, the process continues to step 46. In step 46 the most potential touch sensitive areas for information input, i.e. keys, are enlarged for the next key press on the touch display 10. If the key which was pressed in step 42 was number 0, it means that all number keys are equally probable. That is why in the example of FIG. 3b all the numbers from 0 to 9, reference designator 31b and soft keys 34b and 35b are enlarged on the display 10. On the other hand the area for text and pictures 32b is advantageously concurrently reduced in size, because it is evident that its use is minimal during dialing. After the enlargement, phase 46, the process comes back to step 42 and a further key press is possible.

After each further key press this enlargement process according to the invention recurs. The key enlarged next can be some other key than the key in the first or previous cycle. Also the size of the enlarged keys can vary case-specific. The inventive process continues until some user process has come to an end; a phone number has been dialed or some internal functions in the terminal are completed for example. After that the display 10 according to the invention re-enters to the initial state.

The method according to the invention, which includes the idea to use enlarged keys or information input areas, can also advantageously be used as a guiding agent when teaching a novice user of an electronic device for the first time. The invention helps the new user in two ways. For achieving some goal a key to be pressed next or first is made bigger on the touch display. By that way the user of the electronic device is informed about the best way to begin or proceed. A second known guiding feature is the possibility to change descriptive text of the soft keys on the touch display. According to the invention also the guiding text can be emphasized in the same way as the keys on the touch display.

Above mentioned phases are advantageously fulfilled by appropriate software means, i.e. a computer program, which is installed in the device.

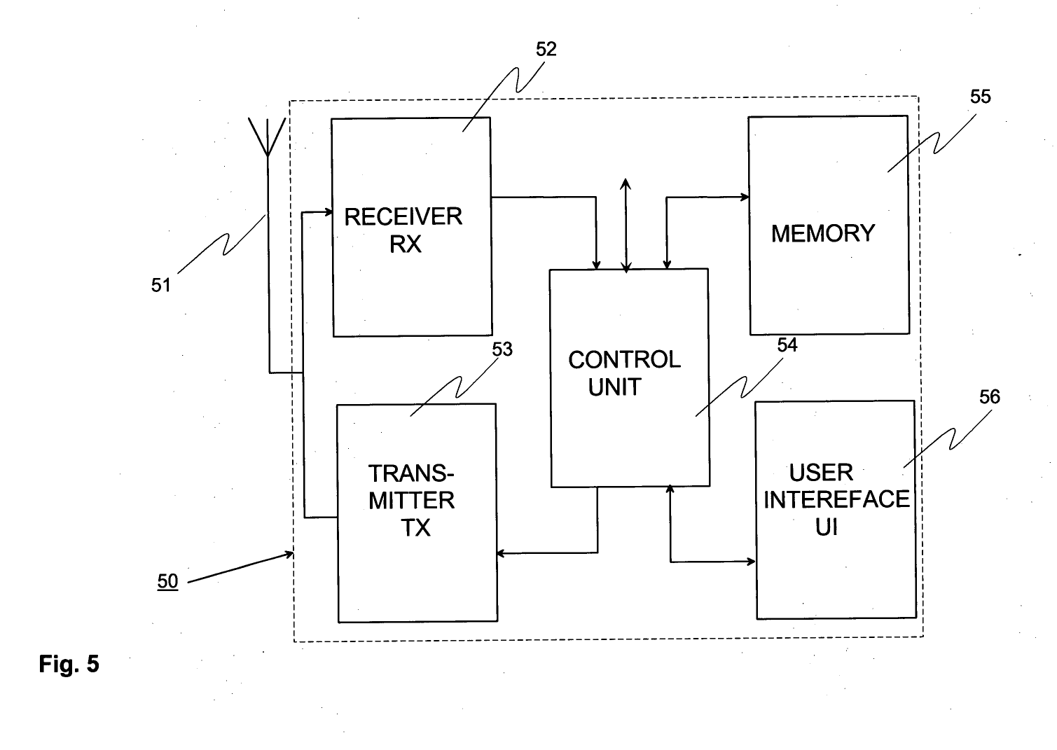

FIG. 5 shows, as an example, main parts of a cellular terminal 50 employing the method according to the invention. The terminal 50 utilizes an antenna 51 in transmitting and receiving messages. Reference designator 52 represents the means constituting a receiver RX by which the wireless terminal 50 receives messages from the cellular network. The receiver RX comprises the means according to the prior art for all received messages.

Reference designator 53 represents the means that constitute the transmitter TX in the wireless terminal 50. The transmitter 53 performs on the signal to be transmitted all the necessary signal processing measures required when communicating with a cellular network.

From the point of view of the invention, the crucial functional unit in the terminal 50 is the control unit 54 which controls the operation of the terminal. It controls the operation of all the main components belonging to the terminal 50. It controls both receive and transmit functions. In the arrangement according to the invention, the control unit 54 determines, whether some of the keys must be enlarged after each key press or not. The control unit 54 uses in the deduction process a computer program according to the invention. The computer program required by the control unit 54 in the operation according to the invention advantageously resides in the memory 55.

The control unit 54 is further used to control the user interface UI 56 as a whole and the memory 55 of the cellular terminal.

The user interface 56 is utilized by the user of the cellular terminal in controlling the functions of the terminal. The display unit belonging to this interface 56 is advantageously a touch display 10 (FIG. 1). According to the invention the control unit 54 can advantageously enlarge some of the keys belonging to this user interface, if the control unit 54 can deduce which keys are the most potential to be pressed next.

Advantageous embodiments according to the invention were described above. The invention is not limited to the embodiments described. For example, it can be used in any electronic device which uses dynamic I/O methods in the user interface. The input can also be any command which is used to control the electronic device through the dynamic I/O interface. The inventional idea can be applied in numerous ways within the scope defined by the claims attached hereto.

1. A method for using an electronic device in which method
a user controls said electronic device by inputting a separate information unit by using input elements of a dynamic I/O arrangement belonging to a user interface of the electronic device
after each input the information unit is identified and it is verified if it is possible to predict which will be a next information unit to be input,
if the prediction of the information unit is successful at least one of input elements in the user interface of the electronic device is emphasized.

2. The method according to claim 1, whereby the input of the information unit is fulfilled by a press of a separate key belonging to the user interface.

3. The method according to claim 1, where the dynamic I/O arrangement comprises a touch display or a projection keyboard.

4. The method according to claim 3, where a size of an input element on the touch display is enlarged if the input element is predicted to be used next.

5. The method according to claim 4, where the size of a separate input element is determined by the predicted probability of the use of the input element.

6. An electronic device comprising
a means for processing and saving information
a means for inputting an information unit in the electronic device by an input element of a dynamic I/O arrangement
a means for assessing, whether it is possible after the input of the information unit to predict which is the next information unit to be input and
a means for emphasizing the predicted input element in the dynamic I/O arrangement.

7. The electronic device according to claim 6, where the input element is defined by an area on a touch display or a projection keyboard.

8. The electronic device according to claim 7, where the input element on the touch display or projection keyboard is enlarged, if the input element is predicted to be used next.

9. The electronic device according to claim 8, where a size of a separate input element is defined on the basis how probable it is to be used next.

10. The electronic device according to claim 9, which is a cellular terminal or PDA.

11. A computer program saved in an electronic device for controlling the electronic device, which software means comprises
a phase where an information unit, which is input into the electronic device via an input element, is identified
a phase where is predicted the most probable information unit to be input next
a phase where is decided if a size of the input element of the predicted information unit is emphasized or not, and
a phase where the input element of the predicted information unit is emphasized after the positive decision.

12. The computer program according to claim 11, where said input of the information unit in the electronic device is fulfilled by a separate key press in a user interface.

13. The computer program according to claim 11, where the emphasizing of the input element is fulfilled by enlarging the size of the input element.

14. The computer program according to claim 11 saved on an information carrier.
